(19) United States
(12) Patent Application Publication
(10) Pub. No.: US 2025/0336603 A1
(43) Pub. Date: Oct. 30, 2025

(54) MULTILAYER CERAMIC CAPACITOR

(71) Applicant: Murata Manufacturing Co., Ltd., Nagaokakyo-shi (JP)

(72) Inventor: Kazuhiro NISHIBAYASHI, Nagaokakyo-shi (JP)

(21) Appl. No.: 19/263,957

(22) Filed: Jul. 9, 2025

Related U.S. Application Data
(63) Continuation of application No. PCT/JP2024/002438, filed on Jan. 26, 2024.

(30) Foreign Application Priority Data
Feb. 24, 2023 (JP) 2023-027028

(51) Int. Cl. H01G 4/008; H01G 4/12; H01G 4/232; H01G 4/248; H01G 4/30

(52) U.S. Cl. CPC H01G 4/008; H01G 4/12; H01G 4/232; H01G 4/248; H01G 4/30

(57) ABSTRACT

A multilayer ceramic capacitor includes a multilayer body includes internal electrode layers and dielectric layers stacked in a stacking direction, external electrodes connected to the internal electrode layers and extending in a length direction intersecting the stacking direction of the multilayer body. An internal electrode layer includes two regions including metals at least partially different from each other. A diffusion region between the two regions in which each of the metals is present.

### CROSS REFERENCE TO RELATED APPLICATIONS

This application claims the benefit of priority to Japanese Patent Application No. 2023-027028 filed on Feb. 24, 2023 and is a Continuation Application of PCT Application No. PCT/JP2024/002438 filed on Jan. 26, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

There is a known multilayer ceramic capacitor including a multilayer body in which dielectric ceramic layers and internal electrode layers are laminated, and including external electrodes disposed on opposite ends of the multilayer body.

In order achieve high performance with such a multilayer ceramic capacitor, attempts have been made to increase an area ratio of the internal electrodes by increasing the volume of the multilayer body by thinning of the external electrodes.

For example, Japanese Unexamined Patent Application, Publication No. 2019-179874 describes a technique in which an external electrode including a Ni layer and a Sn plating layer provided on the Ni layer is thinned by setting the thickness of the Ni layer and the Si content with respect to the Ni content in the Ni layer.

However, thinning the external electrodes increases the likelihood of formation of pinholes that penetrate the external electrodes, and shortens an infiltration path for external moisture. Accordingly, there is a concern that the moisture resistance of the multilayer ceramic capacitor deteriorates.

Thus far, a technique capable of reliably preventing such deterioration of the moisture resistance has not been achieved.

Under the above-described circumstances, in order to develop a multilayer ceramic capacitor with further improved performance, it is required to achieve both a reduction in the thickness of the external electrodes and an improvement in the moisture resistance.

### SUMMARY OF THE INVENTION

Example embodiments of the present invention provide multilayer ceramic capacitors each achieving both thinning of the external electrodes and an improvement in moisture resistance.

The inventor of example embodiments of the present invention has discovered that the moisture resistance of a multilayer ceramic capacitor including an internal electrode layer that includes a counter portion and a lead-out portion is improved by providing a diffusion region in which a metal included in the counter portion and a metal included in the lead-out portion are both present in a boundary portion between the counter portion and the lead-out portion.

A multilayer ceramic capacitor according to an example embodiment of the present invention includes a plurality of internal electrode layers and a plurality of dielectric layers laminated in a lamination direction, and external electrodes in a length direction intersecting with the lamination direction of the multilayer body, and being connected to the plurality of internal electrode layers. Each of the plurality of internal electrode layers includes two regions extending in the length direction and including metals being at least partially different between the two regions, and a boundary portion between the two regions includes a diffusion region in which the metal included in one of the two regions and the metal included in another of the two regions are both present.

Example embodiments of the present invention provide multilayer ceramic capacitors each achieving both thinning of the external electrodes and an improvement in moisture resistance.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 illustrates a multilayer ceramic capacitor according to an example embodiment of the present invention.

FIG. 2 is a cross-sectional view of a multilayer ceramic capacitor according to a first example embodiment of the present invention taken along line II-II in FIG. 1.

FIG. 3 is a cross-sectional view of the multilayer ceramic capacitor according to the first example embodiment of the present invention taken along line III-III in FIG. 2.

FIG. 4 is an exploded view schematically illustrating a structure of an inner layer portion.

FIG. 5 is a cross-sectional view of a multilayer ceramic capacitor according to a second example embodiment of the present invention taken along line II-II in FIG. 1.

FIG. 6 is a cross-sectional view of the multilayer ceramic capacitor according to the second example embodiment of the present invention taken along line VI-VI in FIG. 5.

### DETAILED DESCRIPTION OF THE EXAMPLE EMBODIMENTS

Multilayer ceramic capacitors according to example embodiments of the present invention will be described below with reference to the drawings. The present invention is not limited to the following example embodiments.

The drawings may be schematically simplified for the purpose of illustrating the features of example embodiments of the present invention, and the dimensions of the depicted components or the ratio between the dimensions of the depicted components may appear to be different from those described in the specification.

In addition, components described in the specification may not be illustrated in the drawings or may be illustrated in a reduced number.

### Multilayer Ceramic Capacitor

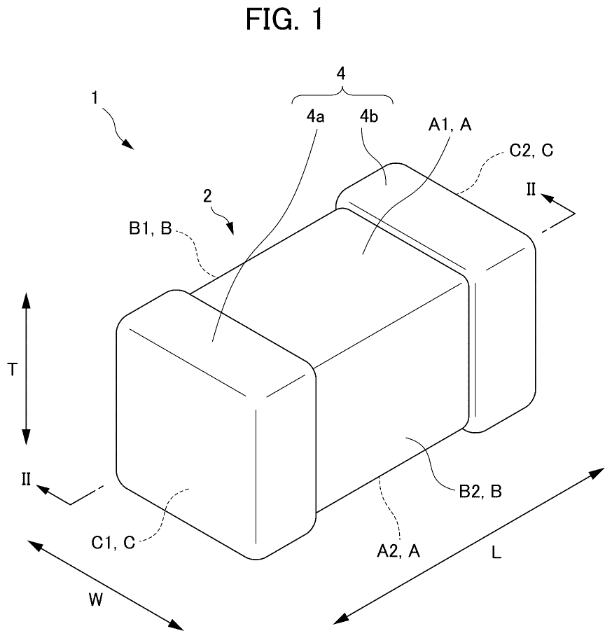

FIGS. 1 to 4 illustrate the shape and structure of a multilayer ceramic capacitor 1 according to a first example embodiment of the present invention.

FIG. 1 illustrates the appearance of the multilayer ceramic capacitor 1.

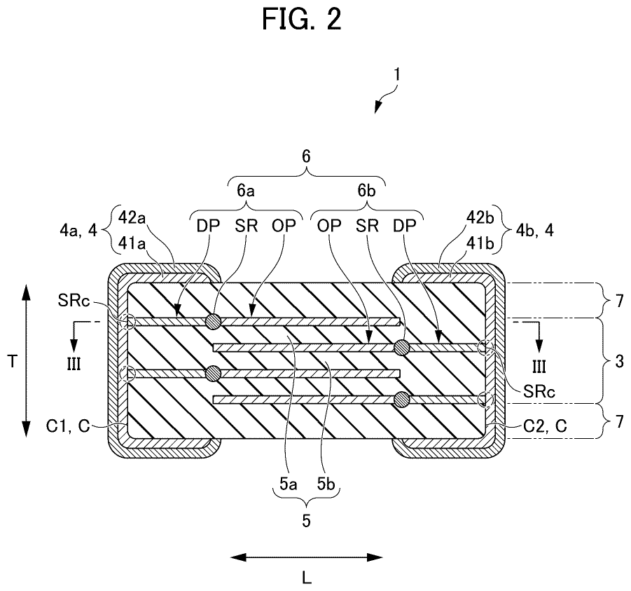

FIG. 2 is a cross-sectional view (LT cross-sectional view) of the multilayer ceramic capacitor 1 taken along the line II-II extending in a central portion in a width direction W shown in FIG. 1.

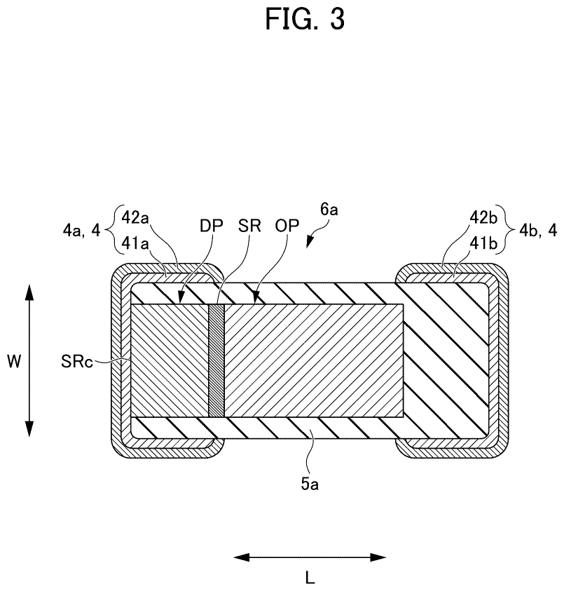

FIG. 3 is a cross-sectional view (LW cross-sectional view) of the multilayer ceramic capacitor 1 taken along the line III-III shown in FIG. 2.

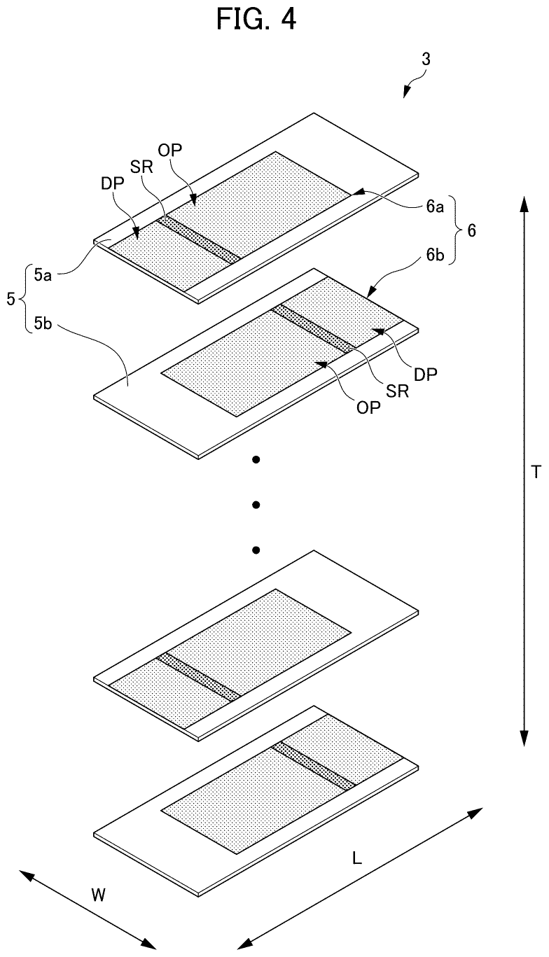

FIG. 4 is a schematic view illustrating the structure of an inner layer portion 3.

The structure of the multilayer ceramic capacitor 1 will be described with reference to a lamination direction T in which dielectric layers and internal electrode layers are laminated, a length direction L orthogonal or substantially orthogonal to the lamination direction T, and a width direction W orthogonal or substantially orthogonal to the lamination direction T and the length direction L.

Although the lamination direction T, the length direction L, and the width direction W are orthogonal or substantially orthogonal to each other in the example embodiments, these directions are not necessarily orthogonal or substantially orthogonal to each other and may intersect with each other.

The multilayer ceramic capacitor 1 includes a multilayer body 2 having a rectangular or substantially rectangular parallelepiped shape.

The multilayer body 2 includes the inner layer portion 3, and a pair of a first main surface A1 and a second main surface A2 opposed to each other in the lamination direction T, a pair of a first end surface C1 and a second end surface C2 opposed to each other in the length direction L orthogonal or substantially orthogonal to the lamination direction T, and a pair of a first side surface B1 and a second side surface B2 opposed to each other in the width direction W orthogonal or substantially orthogonal to both of the lamination direction T and the length direction L.

In many cases, the multilayer ceramic capacitor 1 of the example embodiments is used while with the first main surface A1 facing upward and the second main surface A2 facing in a direction in which the multilayer ceramic capacitor 1 is mounted.

The first main surface A1 and the second main surface A2 are collectively referred to as a main surface A when it is unnecessary to particularly distinguish from each other. The first side surface B1 and the second side surface B2 are collectively referred to as a side surface B when it is unnecessary to particularly distinguish from each other. The first end surface C1 and the second end surface C2 are collectively referred to as an end surface C when it is unnecessary to particularly distinguish from each other.

Although the multilayer ceramic capacitor 1 may have any dimensions without particular limitation, the dimension in the lamination direction T may be about 0.1 mm to about 2.5 mm, the dimension in the length direction L may be about 0.1 mm to about 3.2 mm, and the dimension in the width direction W may be about 0.1 mm to about 2.5 mm, for example.

The inner layer portion 3 is formed by laminating a plurality of dielectric layers 5 and a plurality of internal electrode layers 6.

The internal electrode layers 6 include a first internal electrode layer 6a and a second internal electrode layer 6b.

The first internal electrode layer 6a and the second internal electrode layer 6b are disposed on the dielectric layers 5a and 5b, respectively.

The internal electrode layers 6 extend in the length direction L and have a rectangular or substantially rectangular shape in plan view when viewed in the lamination direction T.

Each internal electrode layer 6 includes a counter portion OP and a lead-out portion DP extending from the counter portion OP to the end surface C and connected to one of external electrodes 4. The counter portions OP of the internal electrode layers 6 adjacent to each other in the lamination direction T face each other to generate a capacitance.

In FIG. 2, the first internal electrode layers 6a are connected to a first external electrode 4a and separated from a second external electrode 4b.

The second internal electrode layers 6b are connected to the second external electrode 4b and separated from the first external electrode 4a.

Each internal electrode layer 6 can be made of, for example, metals such as Ni, Cu, Ag, Pd, Au, etc., a Ag—Pd alloy, a compound including these metals, or an alloy with another metal. On the other hand, the metals included in the counter portion OP are completely or partially different from the metals included in the lead-out portion DP.

Furthermore, only one of the counter portion OP and the lead-out portion DP may include a specific metal.

The counter portion OP and the lead-out portion DP may include metals selected as appropriate. For example, in a case where one of the counter portion OP and the lead-out portion DP includes Cu and the other includes Ni instead of Cu, a boundary portion between the counter portion OP and the lead-out portion DP is allowed to include a diffusion region SR in which the metals of Cu and Ni are diffused respectively from the counter portion OP and the lead-out portion DP or in which the metal is diffused from one into the other.

In a case where one of the counter portion OP and the lead-out portion DP includes Cu and the other includes Ag instead of Cu, the boundary portion between the counter portion OP and the lead-out portion DP include a diffusion region SR in which the metals of Cu and Ni are diffused respectively from the counter portion OP and the lead-out portion DP or in which the metal is diffused from one into the other.

The diffusion region SR is formed by diffusing the metal included in the counter portion OP and the metal included in the lead-out portion DP to an extent that both diffused components can be detected or by diffusing the metal of one of the counter portion OP and the lead-out portion DP into the other, and the metals do not necessarily have to be uniformly distributed in the diffusion region SR.

Therefore, the diffusion region SR may include therein each metal in different concentrations at different positions.

The diffusion of both the metal included in the counter portion OP and the metal included in the lead-out portion DP or the diffusion of the metal from one into the other progresses during firing of the multilayer body, such that the diffusion region SR is formed.

The diffusion of the metal(s) causes the diffusion region SR to expand in volume and to increase in thickness in the lamination direction T, so that the diffusion region SR can fill a gap that may exist at the interface between the internal electrode layer 6 and the dielectric layer 5.

As a result, it is possible to prevent moisture from infiltrating into the multilayer body 2 from the end surfaces C, thus improving the moisture resistance of the multilayer ceramic capacitor.

Normally, the diffusion region SR is thicker in the lamination direction T than the counter portion OP and the lead-out portion DP. However, the diffusion region SR is not always thicker in the lamination direction T than the counter portion OP and the lead-out portion DP because it expands in volume in accordance with the size of the gap between the internal electrode layer 6 and the dielectric layer 5.

In the present example embodiment, a feature is described in which the boundary portion between the counter portion OP and the lead-out portion DP includes the diffusion region SR, but the present invention is not limited to this feature. The internal electrode layer 6 may include two regions provided at any positions in the length direction L and including metals that at least partially differ between the two regions, and a boundary portion between the two regions may include a diffusion region SR in which the metal included in one of the two regions and the metal included in the other are both present.

Furthermore, such a diffusion region SR is not necessarily provided in all of the plurality of internal electrode layers of the multilayer body 2, and may be provided in only one or some of the plurality of internal electrode layers.

For example, the diffusion region SR may be provided only in the internal electrode layer 6 in contact with an outer layer portion 7 because the diffusion region SR provided there provides a significant advantageous effects of improving the moisture resistance.

The dielectric layers 5 are made of a dielectric material.

As the dielectric material, for example, a dielectric ceramic including a component such as BaTiO₃, CaTiO₃, SrTiO₃, CaZrO₃ or the like can be used.

The dielectric material may be obtained by adding a subcomponent such as, for example, a Mn compound, a Fe compound, a Cr compound, a Co compound, a Ni compound, or the like to these main components.

Each dielectric layer 5 may have any thickness without particularly limitation, but the thickness may be, for example, about 0.3 μm to about 2.0 μm in an effective region to generate capacitance that includes the first internal electrode layers 6a and the second internal electrode layers 6b.

The number of the dielectric layers 5 is not particularly limited, but may be, for example, 1 to 6000 in the effective region to generate capacitance that includes the first internal electrode layers 6a and the second internal electrode layers 6b.

Outer layer portions 7 each of which include only a dielectric layer and are devoid of the internal electrode layer 6 are provided adjacent to the upper and lower sides of the inner layer portion 3.

Each outer layer portion 7 may have any thickness without limitation, but the thickness may be, for example, about 15 μm to about 150 μm.

The dielectric layer in each outer layer portion 7 may be thicker than the dielectric layer in the effective region for forming capacitance in which the internal electrode layers 6 are arranged.

The material for the dielectric layer in each outer layer portion may be different from the material for the dielectric layers in the inner layer portion.

FIG. 4 is an exploded view illustrating the inner layer portion 3 disassembled in the lamination direction T into the dielectric layers 5.

The internal electrode layers 6 and the dielectric layers 5 are alternately laminated to define the inner layer portion 3.

The internal electrode layers 6 include the first internal electrode layers 6a and the second internal electrode layers 6b, and the first internal electrode layers 6a and the second internal electrode layers 6b are disposed on the dielectric layers 5a and the dielectric layers 5b, respectively.

Each internal electrode layer 6 includes the counter portion OP and the lead-out portion DP extending from the counter portion OP to the end surface C and connected to one of the external electrodes 4. The counter portions OP of the internal electrode layers 6 adjacent to each other in the lamination direction T face each other to generate a capacitance.

The boundary portion between the counter portion OP and the lead-out portion DP includes the diffusion region SR in which the metal included in the counter portion OP and the metal included in the lead-out portion DP are both present.

To form the above-described diffusion region SR, a conductive paste for forming the counter portion OP and a conductive paste for forming the lead-out portion DP are prepared in the manufacturing process.

The conductive pastes each include a metal powder to define and function as a conductor, an organic solvent, a binder, and a dispersant, and form the internal electrode layers 6 by being sintered on the dielectric layers 5. However, the conductive paste for forming the counter portion OP and the conductive paste for forming the lead-out portion DP include different metals.

On each of ceramic green sheets for forming the dielectric layers 5, the conductive paste for forming the counter portion OP is printed in a predetermined shape to form the counter portion OP, and thereafter, the conductive paste for forming the lead-out portion DP is printed in a predetermined shape to form the lead-out portion DP.

The order of printing the pastes is not limited to this.

As the printing method, for example, a screen printing method, a jet printer method, or the like can be used.

A plurality of material sheets formed in the above described manner and sheets for forming the outer layer portions 7 are laminated together, and the resulting laminate is cut into a predetermined shape, and then fired. As a result, the inner layer portion 3 is formed which includes the dielectric layers 5 and the internal electrode layers 6 laminated therein and in which each boundary portion between the counter portion OP and the lead-out portion DP includes the diffusion region SR formed due to diffusion of the metals of the counter portion OP and the lead-out portion DP into each other or from one to the other.

Alternatively or additionally, providing two regions including different metals in the lead-out portion DP in the length direction L allows for formation of a diffusion region which is located in a boundary portion between the two regions and in which the metals respectively included in the two regions are present.

Furthermore, in a case where a plurality of such boundary portions are provided, a plurality of diffusion regions can be provided in the lead-out portion DP, thus making it possible to reliably improve the moisture resistance of the multilayer ceramic capacitor 1.

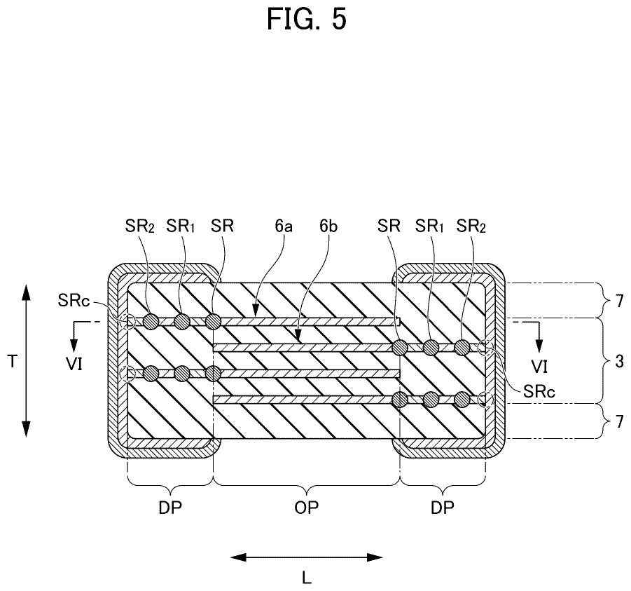

FIG. 5 illustrates a state in which each lead-out portion DP includes, at two locations in the length direction L, boundary portions each of which is between two regions including different metals, and two diffusion regions SR1 and SR2 are provided.

In FIG. 5, the left and right regions of the diffusion region SR1 include different metals, and the left and right regions of the diffusion region SR2 include different metals. However, the metals included in the right region of the diffusion region SR1 and the metals included in the left region of the diffusion region SR2 are not necessarily different from each other and may be the same.

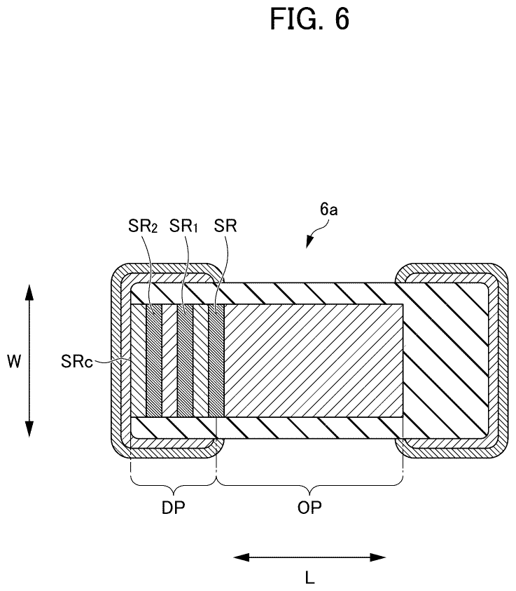

FIG. 6 is an LW cross-sectional view taken along line VI-VI in FIG. 5, and illustrates the first internal electrode layer 6a as viewed in the lamination direction T.

Although FIG. 6 illustrates a state in which the diffusion regions SR1 and SR2 having a strip shape extend perpendicularly or substantially perpendicularly to the length direction L and are arranged parallel or substantially parallel to each other, the diffusion regions do not necessarily have to be perpendicular or substantially perpendicular to the length direction L or have such a continuous strip shape.

Each internal electrode layer 6 may have any thickness without limitation, and the thickness may be, for example, about 0.3 μm to about 1.5 μm.

### Moisture Resistance Load Test

The following three types of multilayer ceramic capacitors were prepared as samples: (a) a conventional multilayer ceramic capacitor including no diffusion region, (b) a multilayer ceramic capacitor including a diffusion region SR in a boundary portion between the counter portion OP and the lead-out portion DP of the internal electrode layer 6 (one diffusion region in each internal electrode layer), and (c) a multilayer ceramic capacitor including a diffusion region in a boundary portion between the counter portion OP and the lead-out portion DP of the internal electrode layer 6 and a diffusion region in a boundary portion in the lead-out portion (two diffusion regions in each internal electrode layer). A moisture resistance load test was performed on 72 test pieces for each of the types (a), (b), and (c).

The moisture resistance load test was performed under the conditions of a temperature of about 85° C., a humidity of about 85% RH, and an applied voltage of about 6.3 V. An insulation resistance IR (Ω) after a lapse of about 100 hours was measured, and the test piece having a Log IR≤about 7.5 was determined as a failure.

Based on the number of test pieces determined to be a failure and the logarithmic value of insulation resistance Log IR, the multilayer ceramic capacitors (a), (b), and (c) were evaluated as excellent (indicated by bullseye symbol (⊙)), good (indicated by circle symbol (o)), or fail (indicated by cross symbol (x)).

### Results

The results of the moisture resistance load test showed that for the multilayer ceramic capacitor (a), four from among the 72 test pieces were determined to be a failure.

For both of the multilayer ceramic capacitor (b) and the multilayer ceramic capacitor of (c), none of the test pieces were determined to be a failure. On the other hand, it was confirmed that the multilayer ceramic capacitor (c) had a higher average value of Log IR than the multilayer ceramic capacitor (b), and maintained more satisfactory insulation resistance.

After the test, the average value of Log IR of the multilayer ceramic capacitor (b) was about 7.9, and the average value of Log IR of the multilayer ceramic capacitor (c) was about 8.2.

Based on the above results of the moisture resistance load test, the multilayer ceramic capacitors (a), (b), and (c) were evaluated as indicated below.

TABLE 1

| Sample | Evaluation Result |
|---|---|
| (a) | X |
| (b) | ◯ |
| (c) | ⊚ |

The first end surface C1 and the second end surface C2 of the multilayer body 2 respectively include the first external electrode 4a and the second external electrode 4b provided thereon.

An end of the lead-out portion DP of each first internal electrode layer 6a is exposed on the first end surface C1 and electrically connected to the first external electrode 4a.

An end of the lead-out portion DP of each second internal electrode layer 6b is exposed on the second end surface C2 and electrically connected to the second external electrode 4b.

Thus, a structure is obtained in which a plurality of capacitor elements are electrically connected in parallel between the first external electrode 4a and the second external electrode 4b.

In the multilayer ceramic capacitor 1 exemplified as example embodiments of the present invention, the first external electrode 4a includes a first base electrode layer 41a and a first plating layer 42a disposed on the first base electrode layer 41a, and the second external electrode 4b includes a second base electrode layer 41b and a second plating layer 42b disposed on the second base electrode layer 41b.

However, the first external electrode 4a and the second external electrode 4b do not necessarily need to have such a two-layer structure.

The first base electrode layer 41a of the first external electrode 4a is disposed on the first end surface C1.

The first base electrode layer 41a is connected to the first internal electrode layers 6a.

In the present example embodiment, the first base electrode layer 41a extends from the first end surface C1 to a portion of the first main surface A1, a portion of the second main surface A2, a portion of the first side surface B1, and a portion of the second side surface B2.

The second base electrode layer 41b of the second external electrode 4b is disposed on the second end surface C2.

The second base electrode layer 41b is connected to the second internal electrode layers 6b.

In the present example embodiment, the second base electrode layer 41b extends from the second end surface C2 to a portion of the first main surface A1, a portion of the second main surface A2, a portion of the first side surface B1, and a portion of the second side surface B2.

The first internal electrode layers 6a and the second internal electrode layers 6b can be made of, for example, metals such as Ni, Cu, Ag, Pd, Au, etc., a Ag—Pd alloy, a compound including these metals, or an alloy with another metal.

The first base electrode layer 41a defining a portion of the first external electrode 4a and the second base electrode layer 41b defining a portion of the second external electrode 4b can be made of, for example, any of Cu, Ni, Ag, Pd, a Ag—Pd alloy, Au, or the like.

The first internal electrode layers 6a and the first base electrode layer 41a may include metals selected as appropriate. On the other hand, the metals included in the lead-out portion DP of each first internal electrode layer 6a are completely or partially different from the metals included in the first base electrode layer 41a.

Furthermore, only one of the lead-out portion DP of each first internal electrode layer 6a and the first base electrode layer 41a may include a specific metal.

For example, in a case where one of the lead-out portion DP of each first internal electrode layer 6a and the first base electrode layer 41a includes Cu and the other includes Ni instead of Cu, a boundary portion between the lead-out portion DP of each first internal electrode layer 6a and the first base electrode layer 41a includes a diffusion region SRc in which metals of Cu and Ni are diffused respectively from the lead-out portion DP of each first internal electrode layer 6a and the first base electrode layer 41a or in which the metal is diffused from one into the other.

In a case where one of the lead-out portion DP of each first internal electrode layer 6a and the first base electrode layer 41a includes Cu and the other includes Ag instead of Cu, the boundary portion between the lead-out portion DP of each first internal electrode layer 6a and the first base electrode layer 41a includes a diffusion region SRc in which metals of Cu and Ni are diffused respectively from the lead-out portion DP of each first internal electrode layer 6a and the first base electrode layer 41a or in which the metal is diffused from one into the other.

Similarly, while the second internal electrode layers 6b and the second base electrode layer 41b may include metals selected as appropriate, the metals included in the lead-out portion DP of each second internal electrode layer 6b are completely or partially different from the metals included in the second base electrode layer 41b.

Furthermore, only one of the lead-out portion DP of each second internal electrode layer 6b and the second base electrode layer 41b may include a specific metal.

For example, in a case where one of the lead-out portion DP of each second internal electrode layer 6b and the second base electrode layer 41b includes Cu and the other includes Ni instead of Cu, a boundary portion between the lead-out portion DP of each second internal electrode layer 6b and the second base electrode layer 41b includes a diffusion region SRc in which metals of Cu and Ni are diffused respectively from the lead-out portion DP of each second internal electrode layer 6b and the second base electrode layer 41b or in which the metal is diffused from one into the other.

In a case where one of the lead-out portion DP of each second internal electrode layer 6b and the second base electrode layer 41b includes Cu and the other includes Ag instead of Cu, the boundary portion between the lead-out portion DP of each second internal electrode layer 6b and the second base electrode layer 41b includes a diffusion region SRc in which metals of Cu and Ni are diffused respectively from the lead-out portion DP of each second internal electrode layer 6b and the second base electrode layer 41b or in which the metal is diffused from one into the other.

Each of the first base electrode layer 41a and the second base electrode layer 41b preferably includes a Ni layer including Ni and a ceramic material.

The Ni layers can be formed by being fired concurrently with the first internal electrode layers 6a and the second internal electrode layers 6b.

The Ni layers are preferably disposed directly on the multilayer body 2.

The diffusion region SRc is formed by diffusing the metal included in the lead-out portion DP of each first internal electrode layer 6a and the metal included in the first base electrode layer 41a to an extent that both diffused components can be detected, by diffusing the metal included in the lead-out portion DP of each second internal electrode layer 6b and the metal included in the second base electrode layer 41b to an extent that both diffused components can be detected, or by diffusing the metal of one into the other, and the metals do not necessarily have to be uniformly distributed in the diffusion region SRc.

Therefore, the diffusion region SR may include therein each metal in different concentrations at different positions.

In the process of firing the first base electrode layer 41a and the second base electrode layer 41b together with the multilayer body 2, the above-described diffusion regions SRc expand in volume and increase in thickness in the lamination direction T due to the diffusion of the metals between the first base electrode layer 41a and each lead-out portion DP and between the second base electrode layer 41b and each lead-out portion DP. As a result, the diffusion regions SRc can fill gaps that may exist at the interface between the lead-out portion DP of the internal electrode layer 6 and the dielectric layer 5.

As a result, it is possible to prevent moisture from infiltrating into the multilayer body 2 from the end surfaces C, thus improving the moisture resistance of the multilayer ceramic capacitor.

Normally, the diffusion region SRc is thicker in the lamination direction T than the lead-out portion DP. However, the diffusion region SRc is not always thicker in the lamination direction T than the lead-out portion DP because it expands in volume in accordance with the size of the gap between the lead-out portion DP of the internal electrode layer 6 and the dielectric layer 5.

The above-described diffusion region SRc is not necessarily provided in all of the plurality of internal electrode layers 6 of the multilayer body 2, and may be provided in only one or some of the plurality of internal electrode layers 6.

For example, the diffusion region SRc may be provided only in the boundary portion between the base electrode layer and the lead-out portion DP of the internal electrode layer 6 in contact with the outer layer portion 7 because the diffusion region SRc provided therein provides a significant advantageous effects of improving the moisture resistance.

The first plating layer 42a and the second plating layer 42b cover the first base electrode layer 41a and the second base electrode layer 41b, respectively.

The first plating layer 42a and the second plating layer 42b may include, for example, at least one of Cu, Ni, Sn, Ag, Pd, a Ag—Pd alloy, Au, or the like.

Each of the first plating layer 42a and the second plating layer 42b may include a plurality of layers.

The first plating layer 42a and the second plating layer 42b each preferably have a two-layer structure including a Ni plating layer and a Sn plating provided on the Ni plating layer.

In this case, the Ni plating layers prevent the first base electrode layer 41a and the second base electrode layer 41b from being eroded by solder when the multilayer ceramic capacitor 1 is mounted.

The Sn plating layers improves solder wettability when the multilayer ceramic capacitor 1 is mounted.

As a result, the mounting of the multilayer ceramic capacitor 1 is facilitated.

The boundary portion between the lead-out portion DP of each first internal electrode layer 6a and the first base electrode layer 41a of the present example embodiment or the boundary portion between the lead-out portion DP of each second internal electrode layer 6b and the second base electrode layer 41b of the present example embodiment corresponds to the boundary portion between the lead-out portion DP and the external electrode 4.

The metal included in a region of the first base electrode layer 41a and is in contact with the boundary portion or the metal included in a region of the second base electrode layer 41b and is in contact with the boundary portion of the present example embodiment corresponds to the metal included in a region of the external electrode and is in contact with a boundary portion of the present invention.

The present example embodiment in which the multilayer ceramic capacitor includes the external electrodes 4 each having a two-layer structure including the base electrode layer and the plating layer has been described above, but the present invention is not limited to this structure of the external electrode and is applicable to a multilayer ceramic capacitor including external electrodes of various configurations. The moisture resistance of the multilayer ceramic capacitor can be improved by providing the configuration in which the boundary portion between the lead-out portion DP and the external electrode 4 includes the diffusion region SRc in which a metal included in a region of the lead-out portion DP and is in contact with the boundary portion and a metal included in a region of the external electrode 4 and is in contact with the boundary portion are both present.

Since the multilayer ceramic capacitor 1 of example embodiments of the present invention includes the diffusion regions SR, SR1, SR2, and/or SRc, the gaps that may exist at the interface between the internal electrode layer 6 and the dielectric layer 5 can be filled.

This feature makes it possible to prevent moisture from infiltrating into the multilayer body 2 from the end surfaces C, thus enabling thinning of the external electrodes 4 and an increase in the volume of the multilayer body 2.

Each external electrode 4 of the multilayer ceramic capacitor 1 has a thickness of, for example about 1.0 μm to about 50.0 μm in the length direction L.

Although the two-terminal multilayer ceramic capacitor 1 has been described as the example embodiments of the present invention, the present invention is not limited to the two-terminal multilayer ceramic capacitor and can be applied to a multi-terminal multilayer ceramic capacitor including three or more terminals.

The present invention is not limited to the example embodiments described above, and can be provided in various configurations without deviating from the scope and spirit of the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor, comprising:
a multilayer body including a plurality of internal electrode layers and a plurality of dielectric layers laminated in a lamination direction; and
external electrodes in a length direction intersecting with the lamination direction of the multilayer body, and being connected to the plurality of internal electrode layers; wherein
each of the plurality of electrode layers includes two regions extending in the length direction and including metals that are at least partially different between the two regions; and
a boundary portion between the two regions includes a diffusion region in which the metal included in one of the two regions and the metal included in another of the two regions are both present.

2. The multilayer ceramic capacitor according to claim 1, wherein
the plurality of internal electrode layers each include a counter portion and a lead-out portion extending from the counter portion to one of the external electrodes;
adjacent internal electrode layers of the plurality of internal electrode layers in the lamination direction face each other at the counter portion;
the counter portion and the lead-out portion include metals at least partially different between the counter portion and the lead-out portion; and
a boundary portion between the counter portion and the lead-out portion includes a diffusion region in which the metal included in the counter portion and the metal included in the lead-out portion are both present.

3. The multilayer ceramic capacitor according to claim 2, wherein
the lead-out portion includes two regions in the length direction and including different metals; and
a boundary portion between the two regions includes a diffusion region in which the metal included in one of the two regions and the metal included in another of the two regions are both present.

4. The multilayer ceramic capacitor according to claim 3, wherein the lead-out portion includes a plurality of the diffusion regions.

5. The multilayer ceramic capacitor according to claim 2, wherein the diffusion region of the boundary portion between the counter portion and the lead-out portion is thicker in the lamination direction than the counter portion.

6. The multilayer ceramic capacitor according to claim 2, wherein a boundary portion between the lead-out portion and one of the external electrodes includes a diffusion region in which a metal included in a region of the lead-out portion and in contact with the boundary portion and a metal included in a region of the one of the external electrodes and in contact with the boundary portion are both present.

7. The multilayer ceramic capacitor according to claim 6, wherein the diffusion region of the boundary portion between the counter portion and the lead-out portion is thicker in the lamination direction than the lead-out portion.

8. The multilayer ceramic capacitor according to claim 2, wherein the diffusion region of the boundary portion between the counter portion and the lead-out portion is thicker in the lamination direction than the lead-out portion.

9. The multilayer ceramic capacitor according to claim 3, wherein the diffusion region of the boundary portion between the counter portion and the lead-out portion is thicker in the lamination direction than the counter portion.

10. The multilayer ceramic capacitor according to claim 3, wherein the diffusion region of the boundary portion between the counter portion and the lead-out portion is thicker in the lamination direction than the lead-out portion.

11. The multilayer ceramic capacitor according to claim 4, wherein the diffusion region of the boundary portion between the counter portion and the lead-out portion is thicker in the lamination direction than the counter portion.

12. The multilayer ceramic capacitor according to claim 4, wherein the diffusion region of the boundary portion between the counter portion and the lead-out portion is thicker in the lamination direction than the lead-out portion.

13. The multilayer ceramic capacitor according to claim 3, wherein a boundary portion between the lead-out portion and one of the external electrodes includes a diffusion region in which a metal included in a region of the lead-out portion and in contact with the boundary portion and a metal included in a region of the one of the external electrodes and in contact with the boundary portion are both present.

14. The multilayer ceramic capacitor according to claim 4, wherein a boundary portion between the lead-out portion and one of the external electrodes includes a diffusion region in which a metal included in a region of the lead-out portion and in contact with the boundary portion and a metal included in a region of the one of the external electrodes and in contact with the boundary portion are both present.

15. The multilayer ceramic capacitor according to claim 5, wherein a boundary portion between the lead-out portion and one of the external electrodes includes a diffusion region in which a metal included in a region of the lead-out portion and in contact with the boundary portion and a metal included in a region of the one of the external electrodes and in contact with the boundary portion are both present.

16. The multilayer ceramic capacitor according to claim 1, wherein the metal included in the one of the two regions is completely or partially different from the metal included in the another of the two regions.

17. The multilayer ceramic capacitor according to claim 2, wherein the metal included in the counter portion is completely or partially different from the metal included in the lead-out portion.

18. The multilayer ceramic capacitor according to claim 1, wherein the one of the two regions includes Ni and the another of the two regions includes Cu.
